(19) United States
(12) Patent Application Publication
(10) Pub. No.: US 2025/0386403 A1
(43) Pub. Date: Dec. 18, 2025

(54) 21st Century Smart Programmable Microwave

(71) Applicant: Tanya G Scott, Richmond, VA (US)

(72) Inventor: Tanya G Scott, Richmond, VA (US)

(21) Appl. No.: 18/735,828

(22) Filed: Jun. 6, 2024

(51) Int. Cl. H05B 6/68

(52) U.S. Cl. CPC H05B 6/68

(57) ABSTRACT

Fully programmable microwave oven marketed from a durable medical equipment (DME) standpoint; such that family/caretaker can easily program in specific ways that currently don't exists with the microwaves we now use. A complete safety lock feature, which allows family/caretaker to totally lock out any use by those living with advanced cognitively impairment. Allows caretakers to program in and lock microwave use features; this greatly increases safety of this appliance in the homes of individual with cognitive impairment. Automation via smart phone controls allows product parameters to be controlled by way of Bluetooth. Smart phone syncing with audio/video applications serves as real time reminder for caretakers of the cognitively impaired person. Health care workers' personalized clinical assessments guide family/caretakers in specific parameters that are safest for home use.

Fully programmable microwave oven marketed from a durable medical equipment (DME) standpoint; such that family/caretaker with allied health professionals (AHP) can easily program in these enhanced specific ways; that currently don't exists with microwaves we now use:

1. A complete lock feature, which allows family/caretaker/AHP to totally lock out any use. Especially useful for those living with advanced cognitively impaired persons, who are very physically mobile, who won't stop using when oven is deemed unsafe. Such families should not have to remove this beloved appliance from the home completely to keep their person safe!
2. Allow family/caretaker/AHP to program in and lock these use features:
   a. time of day,
   b. Have an ability to select between microwave cook times that could be set as we currently use it but also offer an ability to lock in/program 15, 30, or 60 seconds of reheat time. If this type of reheat program feature is selected, the oven could not operate past selection at any point in time unless programmer chooses to make this change. Compromised person would never be afforded ability to program oven. This eliminates chance of mishaps worse than ruined food such as fire!
   c. A brightly colored, over size one button push to start. Easier to move use into functional habit by this population.

The above specifications will serve to ensure dementia users could have improved success of safe use for long period of their declining lives.
3. Automation via smart phone controls to allow product parameters to be controlled by way of Bluetooth remotely.
4. Smart phone sync with audio/video applications to serve as real time reminder for cognitively impaired person for independent safe home use.

1. Medical use by individuals with compromised mental capacities of the microwave oven with unique lock and programmable specifications as listed above, that does not currently exist; medical use of microwave by these individuals is the intellectual property of this sole inventor's idea.

2. Clinical medical prescription use of the microwave with unique lock and programmable specifications as listed above based on person diagnosis/disability which has impaired their mental status. Clinical medical prescription for microwave use as based on person's diagnosis/disability/impairments is the intellectual property of this sole inventor's ideas.

3. Clinical assessment by allied health care workers to guide family/caretakers/prescribing doctor in specific parameters for safest home use, medically tailored to how their loved one presents. Clinical assessment by allied health care workers for microwave use with below specifications is the intellectual property of this sole inventor's ideas.
